(19) United States
(12) Patent Application Publication
(10) Pub. No.: US 2010/0051177 A1
(43) Pub. Date: Mar. 4, 2010

(54) BEAD CONSTRUCTION METHOD FOR A TIRE

(75) Inventors: Christopher David Dyrlund, Canton, OH (US); Gary Robert Burg, Massillon, OH (US); Brian Richard Koch, Hartville, OH (US); Dwayne Richard Huston, Fairlawn, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(73) Assignee: THE GOODYEAR TIRE & RUBBER COMPANY

(21) Appl. No.: 12/617,971

(22) Filed: Nov. 13, 2009

Related U.S. Application Data
(63) Continuation-in-part of application No. 11/447,408, filed on Jun. 6, 2006.

(51) Int. Cl. B29D 30/32

(52) U.S. Cl. 156/135

(57) ABSTRACT

A method and apparatus for manufacturing an annular tire component such as a tire bead includes locating a toroidal support; placing an ejector nozzle in an interference relationship to the toroidal support; and simultaneously ejecting through the nozzle a continuous stream of an elastomeric belt component material in a suitably fluid state and a continuous length of at least one thread component disposed within the stream onto the toroidal support in a predetermined bead configuration. The bead configuration is at least partially defined by a relief in the nozzle ejection port and by the toroidal support onto which the bead is formed. Rotation of the toroidal support may be coupled with the simultaneous ejection of the elastomeric component and thread component in order to create an annular bead structure. A tire may be constructed having a desired bead configuration and location by means of the method and apparatus.

This CIP application claims priority from Divisional patent application Ser. No. 11/447,408, filed Jun. 6, 2006, now pending, which claims priority from U.S. patent application Ser. No. 10/815,568, filed Apr. 1, 2004, now abandoned.

### FIELD OF THE INVENTION

The invention relates to method and apparatus for the construction of an annular component for a tire and, more specifically, to the construction of an annular bead component for a tire built upon a rotating toroidal mandrel.

### BACKGROUND OF THE INVENTION

It is known in the art to build a tire by sequentially laminating strips of tire component material to a rotating toroidal mandrel or core. The components applied to the mandrel in such a laminate fashion may include the tire bead comprising an annular tensile member wrapped by ply cords and shaped to fit the rim of rubber as a base. Some prior art exists wherein tire beads are built onto a rotating toroid by laminating strips of rubber as a base, followed by applying a single spiraled strand of wire/cable, a second layer of rubber, and so on until the appropriate number of bead strands are complete.

While a laminate method of building a tire on a toroidal mandrel is an improvement over alternative methods and has been widely accepted, several shortcomings to such an assembly process remain which prevents the method from representing a solution to all needs of the industry. First, a laminate assembly technique requires that each tire component, including the bead structure, be pre-made into solid strips. The strips are typically inventoried which further adds cost to the process. Storing the strips for a period of time may also cause a degradation in material performance characteristics and adversely affect the quality of a tire made therefrom. Moreover, the process of layering the pre-made bead strips onto a mandrel is laborious and relatively slow, adding cost to the manufactured product. Additionally, the placement and location of the cable(s) in a laminate process is not carefully controlled and the resultant bead structure may suffer from misalignment of the cable within the confines of inner and outer layers. The performance or quality of a tire suffering from cable misplacement may thus be compromised. In addition, the time demands in assembling a tire bead by means of sequentially laminating layers onto a mandrel pursuant to the prior art are considerable and add undesirably to the overall cost of tire manufacture.

### SUMMARY OF THE INVENTION

To be able to build up a tire component, such as a bead structure, consisting of an elastomeric component and a thread-like component (metal or other material), the subject invention simultaneously applies the two materials to a rotating toroidal support or mandrel. A nozzle, pressurized with elastomeric component material at an elevated temperature, is placed in an interference relationship with a rotatable toroid support. The nozzle, according to one aspect of the invention, is provided with a relief at the application point such that the profile of the rubber being applied to the toroid will be determined on multiple sides by the relief in the nozzle ejection point and on an additional side by the surface of the toroid. A second path through the same nozzle is used to run a strand or strands of a thread-like material such that the rubber and strand(s) are applied simultaneously, thereby building up the tire bead component. The ejected elastomeric component and thread component may be applied to a pre-applied elastomeric layer on the toroid. Pursuant to another aspect of the invention, a method is disclosed comprising the steps of placing an ejector nozzle in an interference position to a toroidal support or mandrel and placing and simultaneously ejecting through the nozzle a sufficiently elongate stream of the elastomeric component in a substantially semi-solid state and a sufficiently elongate length of at least one thread component disposed at a preferential location within the stream onto the toroid in a predetermined bead configuration. Pursuant to another aspect of the invention, a tire bead component is built sequentially onto a toroid support by the simultaneous ejection of elastomeric and cable components in the manner previously summarized.

### BRIEF DESCRIPTION OF THE DRAWINGS

The invention will be described by way of example and with reference to the accompanying drawings in which:

FIG. 1 is a perspective view shown partially in section of a toroidal support onto which an annular component is applied pursuant to the invention;

FIG. 2 is a cross sectional view of the toroidal support showing an ejector nozzle positioned in an interference relationship therewith;

FIG. 3 is an enlarged perspective view of an ejector nozzle configured pursuant to the invention; and

FIG. 4 is a front perspective view shown partially in cross-section of the ejector nozzle showing the relief configuration at the nozzle application point.

### DETAILED DESCRIPTION OF THE INVENTION

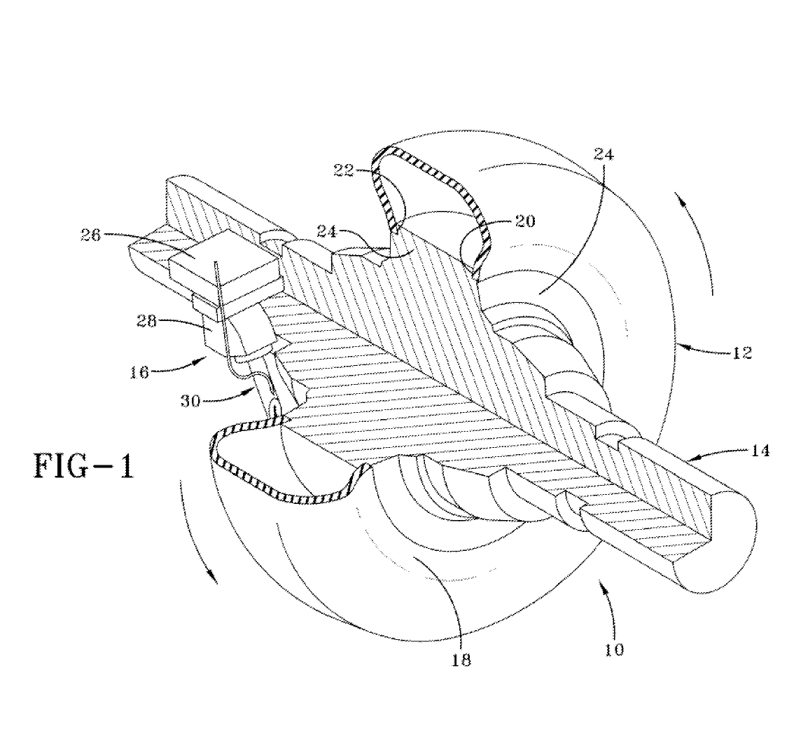

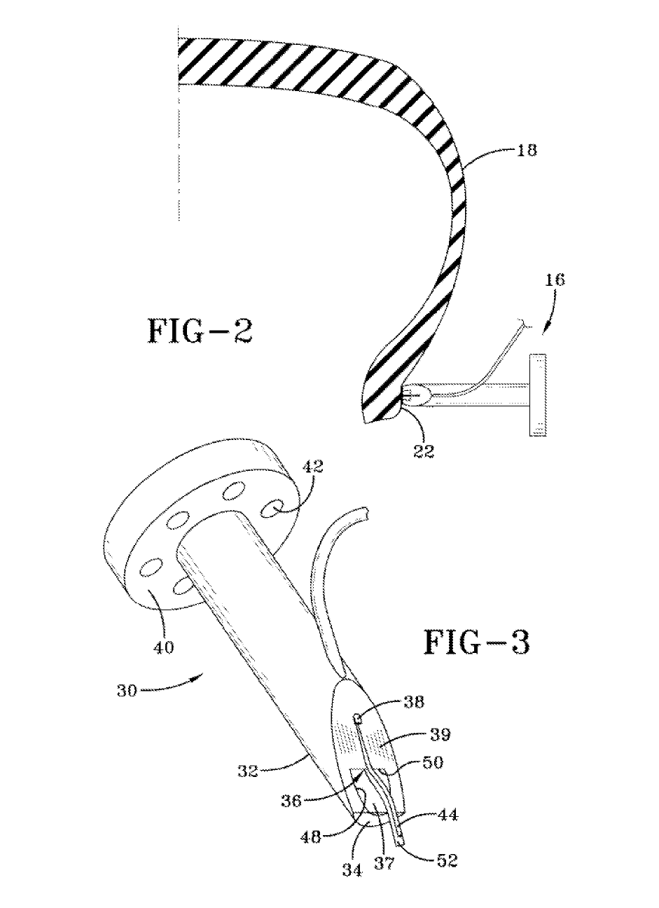

Referring initially to FIGS. 1 and 2, a tire building apparatus 10 is shown generally to include a rotatable toroidal support 12; an axial pivot drive shaft 14, and a bead component ejector assembly 16. The rotatable support 12, also referred herein as a mandrel, includes a toroidal tire shaping surface 18 coupled to a center hub 24 along annular edges 20, 22. The support 12 may be formed from any suitable material common to the industry such as steel. Support 12 may be of unitary, fixed geometrical construction or may comprise segments that collapse or otherwise move relatively to alter the geometry of the support during a tire build cycle. The drive shaft 14 is coupled to rotate the hub 24 and therefrom the annular surface 18 during a tire build. The surface 18 is configured to the shape of a tire to be built on the structure. It is contemplated that layers of elastomeric material such as rubber or a rubber composite will be applied to the surface 18 in a first stage of assembly to form a tire carcass. The carcass will normally include one or more plies, and a pair of sidewalls, a pair of apexes, an inner liner (for a tubeless tire), a pair of chafers and perhaps a pair of gum shoulder strips. Additional components may be used or even replace some of those mentioned above.

Typical tire building machines comprise a tire build drum around which the tire components are wrapped in successive layers including, for example, an inner liner, one or more carcass plies, optional sidewall stiffeners and bead area inserts (e.g., apex), sidewalls and bead wire rings (beads). After this layering, the carcass ply ends are wrapped around the beads, the tires are blown up into a toroidal shape, and the tread/belt package is applied. Typically the tire build drum is in a fixed location on the plant floor, and the various layers of components are applied manually or automatically using tooling registered to reference points on the fixed drum in order to ensure component placement with the desired degree of precision. The tooling is generally fixed relative to the tire building drum, for example a guide wheel on an arm extending from the same frame (machine base) which supports the tire building drum.

The subject invention is intended to provide a novel manner for building an annular component such as a tire bead onto the toroidal support 12. To facilitate the process the applicator assembly 16 is disposed adjacent to the rotating toroidal support 12 and, more specifically, adjacent surface 18 proximate an outer edge 22 thereof as illustrated in FIG. 2. The applicator assembly 16 comprises a mounting bracket 26 and an elastomeric component reservoir 28. As used herein, “elastomeric component” is preferably, but not necessarily, a rubber or rubber composite compound of a type common within the industry as a bead elastomer.

Referring to FIGS. 1, 2, and 3, the assembly 16 further includes an elongate ejector head assembly 30 comprising an elongate nozzle 32 extending to a forward tip 34. A first channel 36 has an opening 37 at the tip 34 and extends rearwardly along the longitudinal axis of the nozzle 32. The forward end of the nozzle includes a tapering surface 39 extending downward to the tip 34. A secondary cable channel 38 extends through a forward end of the nozzle 32 and exits at the sloping surface 39. A mounting annular collar flange 40 is disposed at a rearward end of nozzle 32 and includes a plurality of mounting apertures 42. The configuration and construction of the ejector head assembly 30 is intended to be representative of one of a plurality of alternative configurations that will be apparent to those skilled in the art. The invention is not intended to be limited to the shown location and dispensation of the channels that carry the elastomeric bead component and the cable component to an application end of an ejector assembly. Other configurations that provide for the requisite simultaneous application of an elastomeric and cable component to a targeted annular surface, as explained below, are also intended to be within the scope of the invention.

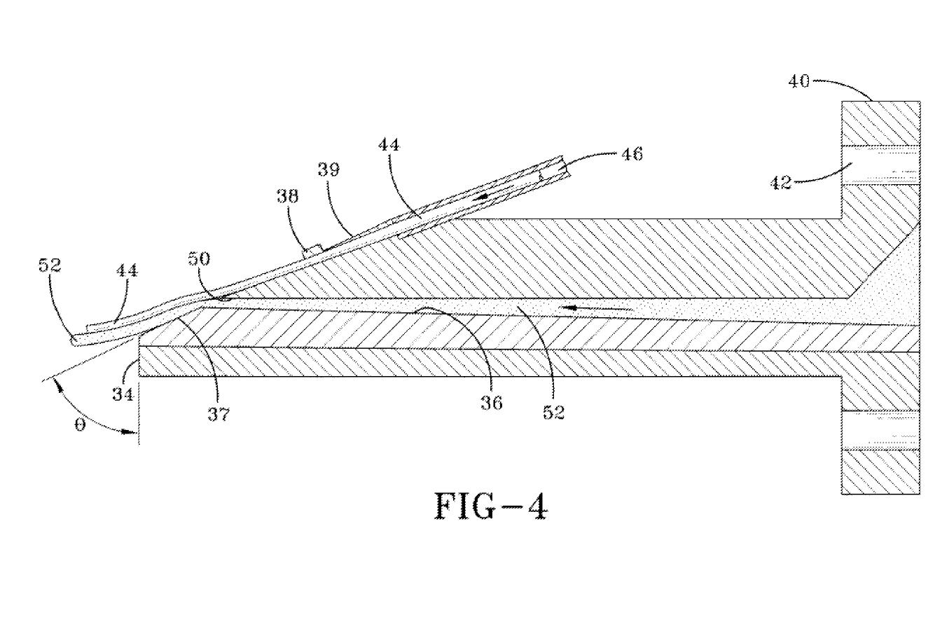

As best illustrated in FIG. 4, a cable 44 is provided that extends through the nozzle forward end to surface 39. The cable 44 is encased within a sheath or cavity 46 rearward of the forward nozzle end and extends therefrom to a cable supplying mechanism such as a spool (not shown) that feeds the cable axially forward to the forward end of nozzle 32 on demand. Cable 44 is constructed from suitable materials conventional to the industry in the construction of a bead cable such as, but not limited to steel. Cable 44 may comprise a single strand or a twisted construction of multiple strands if desired.

The forward end or tip 34 from which the elastomeric compound 52 exits the nozzle 32 as a stream is defined by a relief comprising opposing sidewalls 48 (one of which being shown in the section view FIG. 3) and inner end wall 50. The size and shape of the exit cavity or relief determines the sectional configuration of a stream of elastomeric compound exiting the nozzle 32. An angle θ as shown in FIG. 4 is defined by the slope of the surface 39 and is preferably, but not necessarily, substantially sixty degrees. The relief angle affects application parameters such as flow characteristics and may be varied to adjust such parameters without departing from the invention.

It will be appreciated from FIGS. 1, 2, 3, and 4, the subject applicator assembly 16 intended for placement into an interference relationship with toroidal surface 18 of toroidal support body 12. As used herein, “interference” is meant a proximal relationship sufficiently close to the toroidal surface 18 such that material discharged from the nozzle will be placed at an intended location on surface 18. An “interference” relationship, therefore, may be but is not necessarily a contacting relationship between the nozzle and the surface 18. In the formation of an annular object, such as a tire, the annular support 12 may be rotated and components of the tire layered upon surface 18. Although it is preferable that the toroidal support 12 be rotated while the ejector assembly 16 is moved around the perimeter of the toroid to apply components as the toroid rotates, the practice of the invention is not intended to be so limited. In other configurations, the relative movement of the ejector system 16 and toroidal support may be alternately designed. Means for rotating the support drive shaft 14, the ejector assembly 16, and rotating support 12, are not shown. Suitable rotational drive motors and controls are commercially available and may be readily obtained for such a purpose.

In sequence, an annular bead structure may be constructed onto the support surface 18 pursuant to the invention by the simultaneous application of two materials to the rotating toroidal support. The two components comprise the elastomeric component 52 exiting as a stream from the relief opening in nozzle end 34 and a thread-like component, typically the cable 44 formed of metal or other material, exiting from the exit portal of the cable channel 38. As cable 44 exits from the cable channel 38 in a continuous manner, the cable 44 is disposed within the stream of elastomeric component material exiting from the relief exit cavity 37. The nozzle 32 is pressurized to a suitably high level and the elastomeric component material 52 is driven through the nozzle by conventional apparatus at a suitably elevated temperature to maintain the material 52 in a semi-solid state.

The nozzle ejects a stream of material 52 in a sectional profile determined by the configuration of the relief at the application point; the pressure exerted by the ejector assembly on the toroid; the rubber composite temperature and composition; and the nozzle pressure. The sectional profile of the rubber stream thus is determined on three sides by the sidewalls 48 and 50 of the relief and along a fourth side by the surface 18 of the rotating toroid support. Surface 18 thereby cooperates with the sidewall configuration of the relief to define the sectional shape of the rubber stream as the stream is applied under pressure in a semi-solid state to the rotating toroidal support. While the preferred embodiment recommends a stream of material 52 having a quadrilateral sectional profile, the invention envisions that the relief configuration at the tip of the nozzle may be varied if so desired into alternate configurations to create a stream of material having alternative sectional configurations.

The second channel through the same nozzle 32 is used to run a strand or strands 44 of the thread-like material of the bead. The feed of the cable 44 is directed into the stream of elastomeric component material 52 at an optimum location and the physical encasement of the cable within the stream in such a location ensures that the cable will be optimally located relative to the rotating toroidal support surface. A simultaneous application of the cable and elastomeric component layers thus achieves an efficiency of manufacture as well as an improved accuracy in the placement of the cable within the elastomeric rubber stream and subsequently against the rotating toroidal support. Moreover, the strand 44 may be cut and stopped, while rubber continues to be applied, or the strand 44 may be started into an already flowing stream of material 52.

It is envisioned that the elastomeric component material 52 will be supplied to the application point of the nozzle as a semi-solid, having a sufficiently low viscosity to retain a shape defined by the nozzle relief and the rotating toroid but a sufficiently high viscosity for controlled, pressurized ejection from the nozzle. The rubber material, once applied to the rotating toroidal support, fuses to the rubber-based tire components pre-positioned thereon. The application of a semi-solid bead elastomeric rubber to the pre-disposed tire layers upon the rotating toroid support establishes a positive bond. In addition, the cable(s) disposed within the rubber stream, being applied simultaneously with the rubber component, affords the additional advantage of holding the cable(s) 44 in place with the rubber 52 by essentially providing a coat layer on top or on all sides of the cable. The toroidal surface 18 is thus encircled by an annular bead formed by simultaneous application of the elastomeric component material and the cable component. Thereafter, the remaining tire components may be built to the annular support 12 and cured in a conventional manner to form a finished product.

While the subject invention finds particular application in the formation of a tire bead, other applications are possible. By way of example, without any intent to delimit the invention, the subject disclosure can also find general application in the creation of any elastomeric annular body, including but not limited to tire belts, spiral overlays, and ply components, wherein a portion of the annular body construction consists of a thread-like component ensheathed within an elastomeric component. A simultaneous application of such a thread-like component with an elastomeric component from a nozzle ejection system would, in such applications, prove beneficial.

With reference to FIGS. 2, 3, and 4, it will be seen that the toroidal support 18 has an outer surface substantially in the shape of a tire. The applicator nozzle 16 is placed in an interference position relative to the toroidal support, the applicator nozzle having the angled applicator surface 39 at a forward applicator end 34. The relief cavity formed within the angled applicator surface 39 is defined by internal walls 48, 50 which partially define a predetermined bead configuration formed by the nozzle on the toroidal support. The applicator nozzle first channel 36 communicates with the relief cavity and the second channel 38 receives and routes the thread component or cable 44. The nozzle operates to discharge a substantially semi-solid stream of the elastomeric component from the first channel 36 the relief cavity formed by walls 48, 50.

A length of the thread component or cable 44 exits the second channel 38 of the nozzle, is directed downward along the angled surface 39, and merges with the stream of elastomeric component within the relief cavity. The combined elastomeric component and thread component from the relief cavity is placed onto the toroidal support in the predetermined bead configuration. It is preferred but not necessary that the toroidal support include a pre-applied elastomeric tire layer. The combined elastomeric component and thread component from the relief cavity is applied on the elastomeric tire layer and together therewith define the bead of predetermined configuration.

The toroidal support 18 is preferably rotated during placement of the elastomeric component and the thread component. The predetermined bead configuration is thus formed by at least three internal walls sides (sides 48, 50) of the relief cavity in the nozzle and at least one side by a pre-applied elastomeric layer on the toroidal support. The thread component is preferably positioned within a preferred location, such as the center, within the predetermined bead configuration and is maintained in the preferred location during curing of the elastomeric component. The angled applicator surface 39 is angled at an acute angle θ with respect to a transverse axis of the nozzle as will be seen from FIG. 4. The acute angle may be 60 degrees. The second channel 38 exits to the angled surface 39 and has an outlet to the angled applicator surface 39 located above the relief cavity. From the outlet above the relief cavity, a length of the thread component is routed downward along the angled surface to the relief cavity.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of manufacturing an annular bead comprising an elastomeric component and a thread component for a tire comprising the steps of:
(A) locating a toroidal support having an outer surface substantially in the shape of a tire;
(B) placing an applicator nozzle in an interference position relative to the toroidal support, the applicator nozzle having an angled applicator surface at a forward applicator end including a relief cavity formed within the applicator surface, the relief cavity having internal walls at least partially defining a side of a predetermined bead configuration; and the applicator nozzle having a first channel communicating with the relief cavity and a second channel receiving the thread component;
(C) discharging a substantially semi-solid stream of the elastomeric component through the first channel of the nozzle into the relief cavity;
(D) routing a length of the thread component from the second channel of the nozzle and into the stream of elastomeric component within the relief cavity; and
(E) placing the combined stream of elastomeric component and thread component from the relief cavity onto the toroidal support in the predetermined bead configuration.

2. A method of manufacturing an annular bead according to claim 1, wherein the toroidal support further comprises an elastomeric tire layer and wherein the stream and the thread component are applied on the elastomeric tire layer.

3. A method of manufacturing an annular bead according to claim 2, further comprising defining the predetermined bead configuration by the relief cavity internal walls and the elastomeric tire layer.

4. A method of manufacturing an annular bead according to claim 3, further comprising rotating the toroidal support during placement of the stream of elastomeric component and the thread component.

5. A method of manufacturing an annular bead according to claim 1, further comprising rotating the toroidal support during placement of the stream of elastomeric component and the thread component.

6. A method of manufacturing an annular bead according to claim 5, further comprising defining at least four sides of the predetermined bead configuration by at least three internal walls sides of the relief cavity in the nozzle and at least one side by a pre-applied elastomeric layer on the toroidal support.

7. A method of manufacturing an annular bead according to claim 7, further comprising positioning the thread at a preferred location within the predetermined bead configuration and maintaining the thread in the preferred location during curing of the elastomeric component.

8. A method of manufacturing an annular bead according to claim 7, wherein the preferred location of the thread is substantially in the middle of the predetermined bead configuration.

9. A method of manufacturing an annular bead according to claim 1, wherein the angled applicator surface is angled at an acute angle with respect to a transverse axis of the nozzle.

10. A method of manufacturing an annular bead according to claim 9, wherein the acute angle is substantially 60 degrees.

11. A method of manufacturing an annular bead according to claim 9, wherein the second channel has an outlet to the angled applicator surface located above the relief cavity.

12. A method of manufacturing an annular bead according to claim 11, wherein further comprising routing the length of the thread component downward along the angled surface to the relief cavity.

13. A method of manufacturing an annular bead comprising an elastomeric component and a thread component for a tire comprising the steps of:
(A) locating a toroidal support having an outer surface substantially in the shape of a tire;
(B) placing an applicator nozzle in an interference position relative to the toroidal support, the applicator nozzle having an angled applicator surface including a relief cavity extending into the angled applicator surface defined by internal walls of the relief cavity and positioned proximate an applicator end of the nozzle; the applicator nozzle further having a first channel communicating with the relief cavity and discharging the elastomeric component into the relief cavity; and a second channel receiving the thread component;
(C) routing a length of thread component along the relief cavity;
(D) discharging a substantially semi-solid stream of the elastomeric component through the first channel of the nozzle into the relief cavity;
(E) placing the elastomeric component and the length of thread component from the relief cavity against the outer surface of the toroidal support to form a bead of preferred configuration.

14. A method of manufacturing an annular bead according to claim 13, wherein further comprising applying a layer of elastomeric material on the outer surface of the toroidal support prior to placing the elastomeric component and the length of thread component against the outer surface; and forming the bead of preferred configuration by the internal walls of the relief cavity and the layer of elastomeric material on the outer surface.
